(19) United States
(12) Patent Application Publication
(10) Pub. No.: US 2025/0372848 A1
(43) Pub. Date: Dec. 4, 2025

(54) SECONDARY BATTERY AND METHOD OF MANUFACTURING SAME

(71) Applicant: Samsung SDI Co, Ltd., Yongin-si (KR)

(72) Inventor: Dae Sup Kim, Yongin-si (KR)

(73) Assignee: Samsung SDI Co, Ltd., Yongin-si (KR)

(21) Appl. No.: 18/905,679

(22) Filed: Oct. 3, 2024

(30) Foreign Application Priority Data
May 31, 2024 (KR) 10-2024-0072032

(51) Int. Cl. H01M 50/595; H01M 50/109; H01M 50/153; H01M 50/533; H01M 50/534; H01M 50/586

(52) U.S. Cl. CPC H01M 50/595; H01M 50/109; H01M 50/153; H01M 50/533; H01M 50/534; H01M 50/586

(57) ABSTRACT

A secondary battery includes an electrode assembly including a first electrode and a second electrode, a receiving can having an open first side to receive the electrode assembly and which is electrically connected to the first electrode, a cap assembly covering the open first side of the receiving can to enclose the electrode assembly from outside and being electrically connected to the second electrode, a first tab including a first body coupled to the cap assembly and a first extension bent and extending from the first body, and an insulating layer coated on a first surface of the first extension facing an outer wall of the receiving can.

### CROSS-REFERENCE TO RELATED APPLICATIONS

This present application claims priority to and the benefit under 35 U.S.C § 119 (a)-(d) of Korean Patent Application No.10-2024-0072032, filed on May 31, 2024, in the Korean Intellectual Property Office, the entire disclosure of which is incorporated herein by reference.

### FIELD

The present disclosure relates to a secondary battery and a method of manufacturing the same.

### BACKGROUND

Recently, the growing demand for wearable devices such as Bluetooth-enabled headphones, earphones, smart watches, and body-worn medical devices has increased the demand for ultra-small secondary batteries having a high energy density and a sufficiently small size.

Such secondary batteries are significantly smaller in height than width, depending on the nature of applications, and may include coin batteries and button batteries.

The above information disclosed in this Background section is for enhancement of understanding of the background of the present disclosure, and therefore, it may contain information that does not constitute related (or prior) art.

### SUMMARY

The present disclosure has been proposed to overcome the above-described problems, and an aspect of the present disclosure is to provide a secondary battery having improved reliability by minimizing the occurrence of short circuits between a first tab and a receiving can.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to embodiments of the present disclosure, a secondary battery includes: an electrode assembly including a first electrode and a second electrode; a receiving can having an open first side to receive the electrode assembly and which is electrically connected to the first electrode; a cap assembly covering the open first side of the receiving can to enclose the electrode assembly from outside and the cap assembly being electrically connected to the second electrode; a first tab including a first body coupled to the cap assembly and a first extension bent and extending from the first body; and an insulating layer coated on a first surface of the first extension facing an outer wall of the receiving can.

According to one or more embodiments, the secondary battery may further include an insulating member disposed in a first region of the outer wall of the receiving can corresponding to the first extension.

According to one or more embodiments, the first tab may be coupled to the cap assembly such that the insulating layer and the insulating member are spaced apart from each other by a distance of 50 μm or more.

According to one or more embodiments, an area over which the insulating member is disposed may be greater than an area over which the insulating layer is coated.

According to one or more embodiments, the first extension may be bent and extend downward from a first end of the first body inwardly toward the outer wall of the receiving can.

According to one or more embodiments, the first extension may be bent and extend downward from a first end of the first body inwardly toward the outer wall of the receiving can, and the insulating layer and the insulating member may be provided between the first extension and the outer wall of the receiving can.

According to one or more embodiments, the insulating layer may be implemented as a polymer coating.

According to one or more embodiments, the insulating layer may be implemented as polyimide tape.

According to one or more embodiments, the first tab may include a second extension bent and extending from the first extension.

According to one or more embodiments, the first extension may be bent and extend downward from a first end of the first body inwardly toward the outer wall of the receiving can, and the second extension may be bent and extends upward and outward from a first end of the first extension.

According to one or more embodiments, the insulating layer may be further coated on a region of the second extension.

According to one or more embodiments, a first angle between the first body and the first extension bent inward may be smaller than a second angle between the first extension and the second extension bent outward.

According to one or more embodiments, a first surface of the first body not in contact with the cap assembly may be coated with nickel (Ni). The first surface of the first extension facing the outer wall of the receiving can may be coated with the insulating layer, and a second surface of the first extension is coated with tin (Sn).

According to one or more embodiments, opposite surfaces of the second extension may be coated with tin (Sn).

According to one or more embodiments, the secondary battery may further include a second tab coupled to a second side of the receiving can opposite the open first side.

According to one or more embodiments, the cap assembly may include: a cap plate including a first open area and coupled to the open first side of the receiving can; a cap covering the cap plate and enclosing the electrode assembly, the cap extending downward through the first open area and being connected to the second electrode; and a cap insulating layer disposed between the cap plate and the cap to insulate the cap plate and the cap.

According to other embodiments of the present disclosure, a method of manufacturing a secondary battery includes: forming an electrode assembly including a first electrode and a second electrode; receiving the electrode assembly in a receiving can having an open first side and electrically connecting the receiving can to the first electrode; electrically connecting the second electrode to a cap assembly of the secondary battery and covering and enclosing the open first side of the receiving can; and coupling a first tab to the cap assembly, wherein the first tab includes a first body and a first extension bent and extending from the first body, a first surface of the first extension being coated with an insulating layer.

According to other embodiments of the present disclosure, the method may further include, before coupling the first tab to cap assembly, attaching an insulating member to a first region of an outer wall of the receiving can facing the first extension.

According to other embodiments of the present disclosure, the insulating member may be implemented as polyimide tape.

According to other embodiments of the present disclosure, the first extension may be bent and extending inward and downward from a first end of the first body; and the first tab may further comprise a second extension bent and extending outward and upward from a first end of the first extension.

According to one or more embodiments of the present disclosure, the housing may be removed from the receiving can without causing a short circuit between the first tab and the receiving can.

In addition, according to one or more embodiments of the present disclosure, the size of a secondary battery may be further reduced by removing the housing of the receiving can.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a perspective view showing a secondary battery according to an embodiment of the present disclosure;

FIG. 2 illustrates a side view showing a secondary battery according to an embodiment of the present disclosure;

FIG. 3 illustrates a cross-sectional view showing a secondary battery according to an embodiment of the present disclosure;

FIG. 4 illustrates an enlarged view showing an area A of FIG. 2 according to an embodiment of the present disclosure;

FIG. 5 illustrates an angle at which a first tab is bent according to an embodiment of the present disclosure;

FIG. 6 illustrates a plan view showing a first tab according to an embodiment of the present disclosure;

FIG. 7 illustrates a bottom view showing a first tab according to an embodiment of the present disclosure;

FIG. 8 illustrates a side view showing a secondary battery according to another embodiment of the present disclosure;

FIG. 9 illustrates a side view showing a secondary battery according to another embodiment of the present disclosure;

FIG. 10 illustrates a side view showing a secondary battery according to another embodiment of the present disclosure;

FIG. 11 illustrates a flowchart showing a method of manufacturing a secondary battery according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

A typical coin or button battery includes a housing can to receive an electrode assembly having a jelly roll structure and a cap assembly bonded to the upper portion of the housing can to seal the electrode assembly from the outside. A positive electrode tab extending upward from the electrode assembly is configured to be connected to an electrode terminal provided on the cap assembly, and a negative electrode tab extending downward from the electrode assembly is configured to be connected to the housing can. The electrode terminal of the cap assembly is connected to an external first tab and the receiving can is connected to an external second tab, so that the electrode assembly can be charged and discharged through the first tab and the second tab. In addition, in a case where the cap assembly and the first tab are connected, because a short circuit may occur between the receiving can and the first tab on the outside, a receiving can housing is provided in a region where the receiving can and the first tab may be in contact with each other.

For such secondary batteries, there is a need to improve the reliability of secondary batteries by preventing short circuits between the first tab and the receiving can.

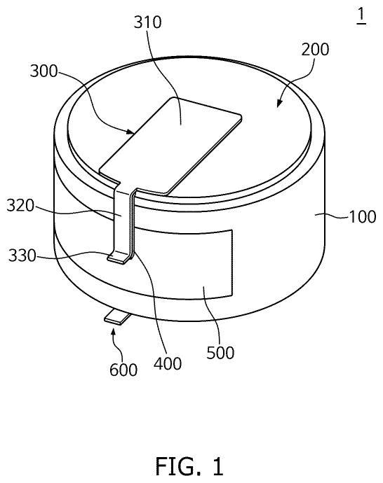

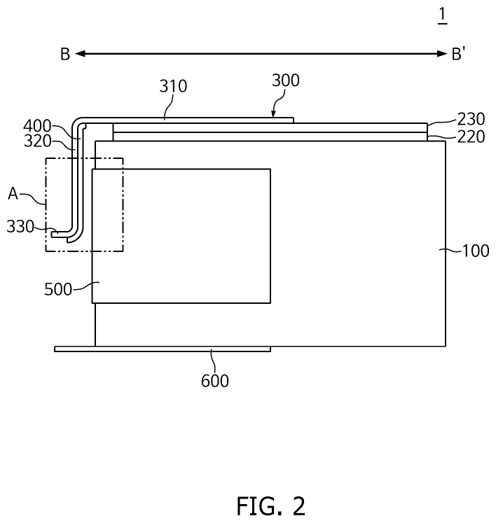

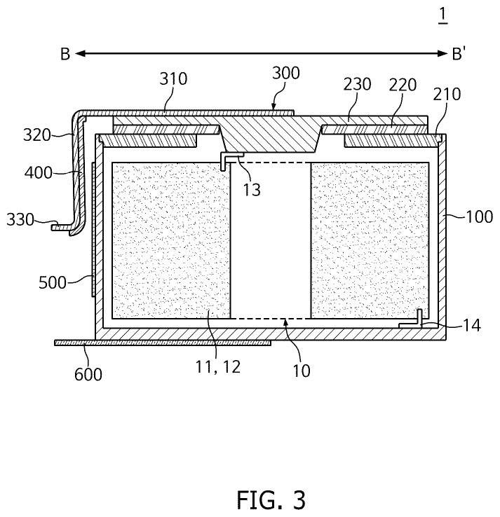

FIG. 1 illustrates a perspective view showing a secondary battery according to an embodiment of the present disclosure. FIG. 2 illustrates a side view showing a secondary battery according to an embodiment of the present disclosure. FIG. 3 illustrates a cross-sectional view showing a secondary battery according to an embodiment of the present disclosure.

A secondary battery according to one or more embodiments is a micro-sized secondary battery and may be a coin cell or a button cell but is not limited thereto and may be a cylindrical or pin-type battery. The coin cell or button cell is a battery in the form of a thin coin or button and may refer to a battery having a ratio of height to diameter (height/diameter) of 1 or less but is not limited thereto. Because the coin cell or button cell is generally cylindrical, the cross section in the horizontal direction is generally circular. However, the cross section in the horizontal direction is not limited thereto and may have an elliptical or polygonal shape. The diameter may refer to a maximum distance in the horizontal direction of the battery, and the height may refer to a maximum distance in the vertical direction of the battery (e.g., distance from the flat bottom surface to the flat top surface of the battery).

Referring to FIGS. 1 to 3, a secondary battery 1 according to an embodiment of the present disclosure may include an electrode assembly 10, a receiving can 100, a cap assembly 200, a first tab 300, an insulating layer 400, an insulating member 500, and a second tab 600.

According to an embodiment, the electrode assembly 10 may include a first electrode 11 and a second electrode 12. Herein, the first electrode 11 may be a negative electrode, and the second electrode 12 may be a positive electrode. For example, the electrode assembly 10 may be a wound electrode assembly 10 formed by providing a separator, which is an insulator, between the first electrode 11 and the second electrode 12, followed by winding the first and second electrodes 11, 12. In another example, the electrode assembly 10 may be a laminated electrode assembly 10 formed by alternately stacking the first electrode 11 and the second electrode 12 with the separator provided therebetween, or may be any structure including the first electrode 11 and the second electrode 12. The structure of the electrode assembly 10 described above is illustrative, and the present disclosure is not limited thereto.

According to one embodiment, a positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0sb≤0.5, and 0≤c≤0.05); LiaNi1-b-cCobXcO2-αDα (0.90<a≤1.8, 0<b>0.5, 0≤c≤0.5, and 0≤α≤2); LiaNi1-b-cMnbXcO2-αDα (0.90≤a≤1.8, 0≤b≤0.5, 0≤c≤0.5, and 0≤α≤2); LiaNibCocL1dGeO2 (0.90≤a≤1.8, 0sb≤0.9, 0≤c≤0.5, 0sd≤0.5, and 0≤e≤0.1); LiaNiGbO2 (0.90≤a≤1.8 and 0.001sb≤0.1); LiaCoGbO2 (0.90≤a≤1.8 and 0.001≤b≤0.1); LiaMn1-bGbO2 (0.90≤a≤1.8 and 0.001sb≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0sf≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

For example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but is not limited thereto.

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

According to an embodiment, the electrode assembly 10 may further include a positive electrode tab 13 and a negative electrode tab 14. The positive electrode tab 13 may be separately formed and connected to an uncoated portion of the second electrode 12, or may be formed by stamping or punching a portion of the uncoated portion. The positive electrode tab 13 may extend upward from the uncoated portion and contact the cap assembly 200. The above-described configuration of the positive electrode tab 13 in contact with the cap assembly 200 is illustrative, but is not intended to be limiting. The positive electrode tab 13 and the cap assembly 200 may electrically connect the second electrode 12 and the cap assembly 200. The negative electrode tab 14 may be separately formed and connected to the uncoated portion of the first electrode 11, or may be formed by stamping a portion of the uncoated portion. The negative electrode tab 14 may extend downward from the uncoated portion and contact the receiving can 100. The above-described configuration of the negative electrode tab 14 in contact with the receiving can 100 is illustrative, but is not intended to be limiting. The contact between the negative electrode tab 14 and the receiving can 100 may electrically connect the first electrode 11 and the receiving can 100. An example in which the positive electrode tab 13 is electrically connected to the cap assembly 200 and the negative electrode tab 14 is electrically connected to the receiving can 100 has been described, but a reverse case is also possible, and this is not intended to be limiting.

According to an embodiment, the receiving can 100 may have an open side to receive the electrode assembly 10, and may be electrically connected to the first electrode 11. The receiving can 100 may form the overall contour of the secondary battery 1. For example, the receiving can 100 may have an open cylindrical shape. The receiving can 100 may include a circular bottom surface and a sidewall extending vertically from a circumference of the bottom surface. The receiving can 100 may be formed such that the diameter of the bottom surface is greater than the height of the sidewall, such that the secondary battery 1 may be implemented as a button or coin battery.

According to an embodiment, the top surface opposite the bottom surface of the receiving can 100 may be open to expose a receiving space capable of receiving the electrode assembly 10. After the electrode assembly 10 is received in the receiving can 100, the cap assembly 200 may cover the open first side of the receiving can 100 and seal the electrode assembly 10. Specifically, the top surface of the sidewall of the receiving can 100 may have a portion stepped from the outside to the inside. For engagement with the stepped portion of the receiving can 100, the cap plate 210 of the cap assembly 200 may have a corresponding stepped portion on the outer surface. Accordingly, referring to FIG. 3, the outer surface of the cap plate 210 may be structured such that the upper portion protrudes more than the lower portion. The stepped portion of the receiving can 100 and the stepped portion of the outer surface of the cap plate 210 may be engaged and joined by metal bonding (e.g., welding, brazing, or soldering).

According to an embodiment, the receiving can 100 may be connected to the first electrode 11 via a negative electrode tab 14 to function as a negative electrode. The receiving can 100 may be coupled to the second tab 600 that is an external terminal to be connected to a load. The second tab 600 may be disposed on the other side of the receiving can 100 opposite the open first side.

As will be described later, a portion of the outer wall of the receiving can 100 may face a first extension 320 of the first tab 300 connected to the cap assembly 200. Accordingly, the receiving can 100 may have the insulating member 500 disposed on a region of the outer wall corresponding to the first extension 320, thereby providing insulation between the receiving can 100 and the first tab 300.

According to an embodiment, the cap assembly 200 may cover the open first side of the receiving can 100 to seal the electrode assembly 10 from the outside. The cap assembly 200 may be electrically connected to the second electrode 12 of the electrode assembly 10. The cap assembly 200 may be coupled to the first tab 300 that is an external terminal to be connected to a load.

According to an embodiment, the cap assembly 200 may include a cap plate 210, a cap insulating layer 220, and a cap 230. The cap plate 210 may include a first open area, and may be seated on an outer wall of the receiving can 100. As described above, the cap plate 210 may be shaped such that the upper portion protrudes more than the lower portion, and may be coupled to the receiving can 100 while engaging with a stepped portion of the outer wall of the receiving can 100. The cap plate 210 may be disc-shaped, with a first open area provided in the central portion and an outer end corresponding to the shape of the receiving can 100. The cap 230 may have a protrusion in the central portion, and the protrusion of the cap 230 may extend through the first open area of the cap plate 210 and be in contact with the positive electrode tab 13 connected to the second electrode of the electrode assembly 10.

According to an embodiment, the cap insulating layer 220 may be disposed on the cap plate 210. The cap insulating layer 220 may be disposed between the cap plate 210 and the cap 230 to insulate the cap 230 and the cap plate 210 from each other. The cap insulating layer 220 may be disposed on a peripheral region of the protrusion of the cap 230. Because the cap plate 210 is connected to the receiving can 100 in contact with the negative electrode tab 14 and the cap 230 is connected to the positive electrode tab 13, the cap insulating layer 220 may be disposed between the cap plate 210 and the cap 230 to insulate the cap plate 210 and the cap 230. The cap insulating layer 220 may be disc-shaped with a second open area provided in the central portion thereof. The cap insulating layer 220 may be disposed on the cap plate 210, and may have a second open area that is concentric with the first open area of the cap plate 210 but has a diameter smaller than or equal to the diameter of the first open area, thereby electrically insulating the cap 230 disposed over the cap insulating layer 220 from the cap plate 210.

According to an embodiment, the cap insulating layer 220 may have a size corresponding to the size of the cap 230 disposed thereover. That is, the cap insulating layer 220 may have a diameter that is greater than or equal to the diameter of the cap 230, thereby electrically insulating the cap 230 and the cap plate 210.

According to an embodiment, the cap 230 may cover the cap plate 210 and enclose or seal the electrode assembly 10. The protrusion of the cap 230 may extend through the first open area of the cap plate 210 and be connect to the second electrode 12 of the electrode assembly 10. The cap 230 may be disposed over the cap insulating layer 220 to be electrically insulated from the cap plate 210. The cap 230 may extend from the center of the bottom surface to extend through the first open area without contacting the first open area, and may be in contact with the positive electrode tab 13 of the electrode assembly 10. The cap 230 may be connected to the second electrode 12 through the positive electrode tab 13 to function as a positive electrode. The cap 230 may be disposed on the uppermost layer of the cap assembly 200, and may be connected to the first tab 300, which is an external terminal to be connected to a load.

According to an embodiment, the first tab 300 may be an external terminal to be connected to a load. The first tab 300 may be electrically connected to the second electrode 12 of the electrode assembly 10 through the cap assembly 200 to function as a positive electrode.

According to an embodiment, the first tab 300 may include a first body 310 coupled to the cap assembly 200 and the first extension 320 bent and extending from the first body 310.

According to an embodiment, the first body 310 may be disposed on the cap 230 disposed on the top layer of the cap assembly 200. A region of the first body 310 may be in contact with the top surface of the cap 230 around the center of the top surface of the cap 230 in a peripheral direction. The remaining region of the first body 310 may extend horizontally so as not to contact the cap plate 210 or the receiving can 100. The first body 310 may extend horizontally beyond the outermost edge of the receiving can 100 and be bent inwardly toward the outer wall of the receiving can 100.

According to an embodiment, the first extension 320 may be bent and extend downward from a first end of the first body 310 inwardly toward the outer wall of the receiving can 100. A first surface of the first extension portion 320 facing the outer wall of the receiving can 100 may be coated with the insulating layer 400. As described herein, the insulating member 500 may be disposed on a first region of the outer wall of the receiving can 100 corresponding to the first extension 320. The insulating layer 400 coated on the first extension portion 320 and the insulating member 500 disposed on the outer wall of the receiving can 100 may prevent a short circuit between the first extension portion 320 and the receiving can 100.

According to an embodiment, when viewed from above, the side-to-side width of the first body 310 may be greater than the side-to-side width of the first extension portion 320. The first body 310 may be formed with a larger side-to-side width to be coupled to the cap 230, and the first extension 320 may be formed with a smaller side-to-side width to easily bend and prevent short-circuiting with the receiving can 100.

According to an embodiment, the first tab 300 may further include a second extension 330 bent and extending from the first extension 320. The second extension 330 may be bent upward and extend outward from a first end of the first extension 320.

According to an embodiment, the insulating layer 400 may be coated on the first surface of the first extension 320. As described herein, the insulating layer 400 may be coated on the first surface of the first extension 320 facing the outer wall of the receiving can 100. The insulating layer 400 may be, but is not limited to, a polymer coating. The insulating layer 400 may be coated with a thickness of 20 μm to 60 μm, but is not limited thereto.

According to an embodiment, the insulating member 500 may be disposed on a first region of the outer wall of the receiving can 100. The insulating member 500 may be disposed on the region of the outer wall of the receiving can 100 corresponding to the first extension 320. The insulating member 500 may include, but is not limited to, polyimide. The insulating member 500 may be implemented as and/or with tape for attachment, but is not limited thereto.

According to an embodiment, the area over which the insulating member 500 is attached and disposed on the outer surface of the receiving can 100 may be greater than the area over which the insulating layer 400 is coated on the first extension 320. This is to attach the insulating member 500 to a large area of the outer surface of the receiving can 100 in order to prevent the first extension 320 from moving or bending, which would otherwise cause a short circuit with the receiving can 100.

According to an embodiment, the second tab 600 may be coupled to a second surface of the receiving can 100 opposite the open first surface. The second tab 600 may be an external terminal to be connected to a load. The second tab 600 may be electrically connected to the first electrode 11 of the electrode assembly 10 through the receiving can 100 to function as a negative electrode.

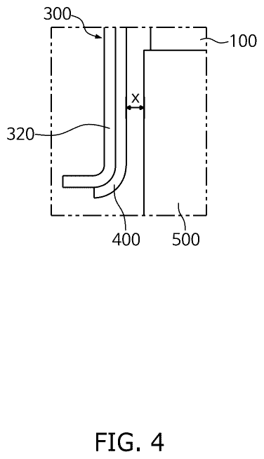

FIG. 4 illustrates an enlarged view showing an area A of FIG. 2 according to an embodiment of the present disclosure.

Referring to FIGS. 2 and 4, according to an embodiment, the first extension 320 may be spaced apart from the outer wall of the receiving can 100.

The first tab 300 may be coupled to the cap assembly 200 by adjusting the position thereof so that the first insulating layer 400 coated on the first extension 320 and the insulating member 500 attached to the outer wall of the receiving can 100 are spaced apart by at least a predetermined distance X. For example, the first tab 300 may be coupled to the can assembly such that the insulating layer 400 coated on the first extension 320 and the insulating member 500 attached to the outer wall of the receiving can 100 are spaced apart by a distance of 50 μm or more.

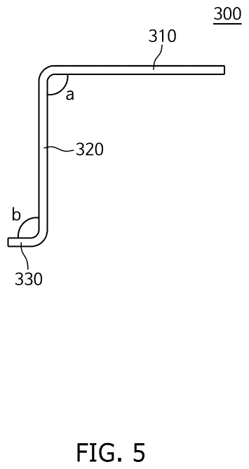

FIG. 5 illustrates an angle at which the first tab is bent according to an embodiment of the present disclosure.

Referring to FIG. 5, the first tab 300 may include the first body 310, the first extension portion 320, and the second extension portion 330. As described above, the first extension 320 may be bent and extend downward from the first end of the first body 310 inwardly toward the outer wall of the receiving can 100. The second extension 330 may be bent upward and extend outward from the first end of the first body 310.

According to an embodiment, a first angle a between the first body 310 and the first extension 320 defined by the inward bending of the first extension 320 may be smaller than a second angle b between the first extension 320 and the second extension 330 defined by the outward bending of the second extension 330. For example, the first extension 320 may be bent in the range of the first angle a from 87° to 93°, and the second extension 330 may be bent in the range of the second angle b from 90° to 96°, but is not limited thereto.

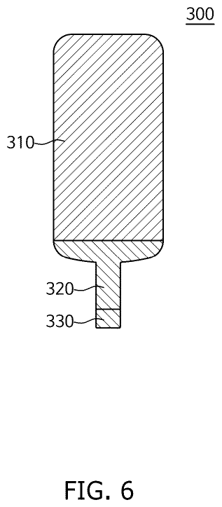

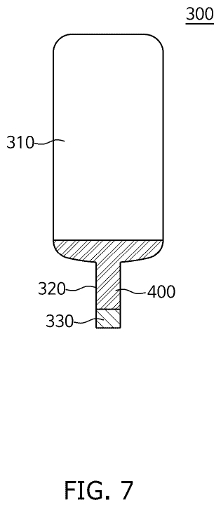

FIG. 6 illustrates a plan view showing the first tab according to an embodiment of the present disclosure. FIG. 7 illustrates a bottom view showing the first tab according to an embodiment of the present disclosure.

Referring to FIGS. 6 and 7, according to an embodiment, the first tab 300 may be coated with nickel (Ni), tin (Sn), and the insulating layer 400.

According to an embodiment, the first surface of the first body 310 not in contact with the cap assembly 200 may be coated with nickel (Ni). The thickness of the Ni coating on the first surface of the first body 310 may range from 0.5 μm to 2 μm, but is not limited thereto.

According to an embodiment, as described above, the first surface of the first extension 320 facing the outer wall of the receiving can 100 may be coated with the insulating layer 400. The thickness of the insulating layer 400 coated on the first surface of the first extension 320 may range from 20 μm to 60 μm, but is not limited thereto. A second surface of the first extension 320 may be coated with tin (Sn). The thickness of the Sn coating on the second surface of the first extension 320 may range from 3 μm to 5 μm, but is not limited thereto.

According to an embodiment, the second extension 330 may be coated with tin (Sn) on opposite surfaces. The thickness of the Sn coating on each of the opposite surfaces of the second extension 330 may range from 3 μm to 5 μm, but is not limited thereto. The second surface of the first extension 320 and the opposite surfaces of the second extension 330 may be coated with Sn at a substantially same time or different times.

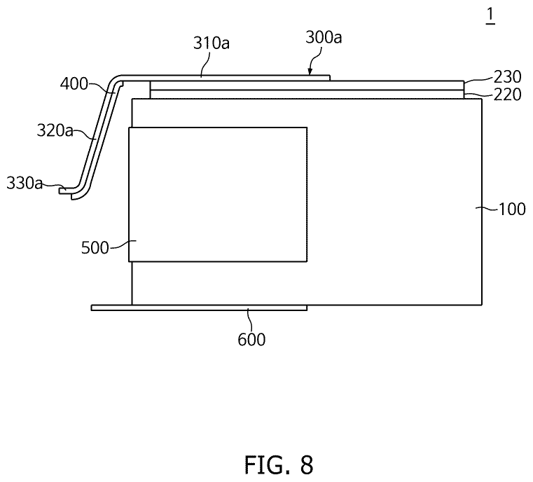

FIG. 8 illustrates a side view showing a secondary battery according to another embodiment of the present disclosure.

Referring to FIG. 8 in comparison to FIG. 2, according to another embodiment, a first extension 320a may be bent and extend from a first body 310a toward the outer wall of the receiving can 100. The angle between the bent first extension 320a and the first body 310a may be defined to be greater than the angle between the first extension 320 and the first body 310 shown in FIG. 2. The distance between the first extension 320a and the outer wall of the receiving can 100 may be increased. Accordingly, a short circuit between the first tab 300a and the receiving can 100 may be prevented.

This embodiment of the present disclosure is the same as the embodiment of the present disclosure described above with reference to FIG. 2, except that the configuration with respect to the angle at which the first tab 300a of the secondary battery 1 is bent is different from the configuration with respect to the angle at which the first tab 300 of the secondary battery 1 is bent described above with reference to FIG. 2, and therefore detailed description of the remaining configurations will be omitted.

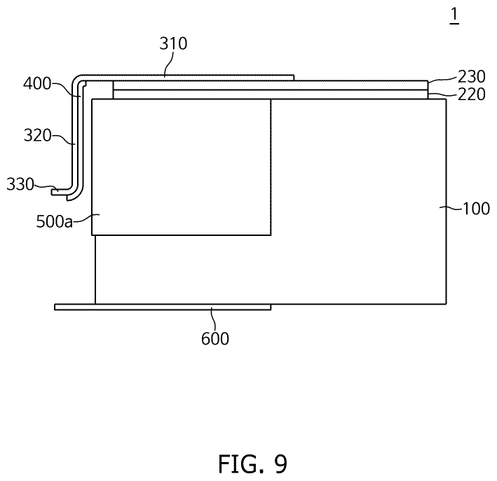

FIG. 9 illustrates a side view showing a secondary battery according to another embodiment of the present disclosure.

Referring to FIG. 9 with respect to FIG. 2, according to another embodiment, an insulating member 500a may be disposed to be attached to a first region including the top end of the outer wall of the receiving can 100 corresponding to the first extension 320. Because the top end of the outer wall of the receiving can 100 may be most adjacent to the first extension 320, the insulating member 500a is attached to the top end of the outer wall of the receiving can 100.

This embodiment of the present disclosure is the same as the embodiment of the present disclosure described above with reference to FIG. 2, except that the configuration with respect to the position at which the insulating member 500a of the secondary battery 1 is attached is different from the configuration with respect to the position at which the insulating member 500 of the secondary battery 1 is attached described above with reference to FIG. 2, and therefore detailed description of the remaining configurations will be omitted.

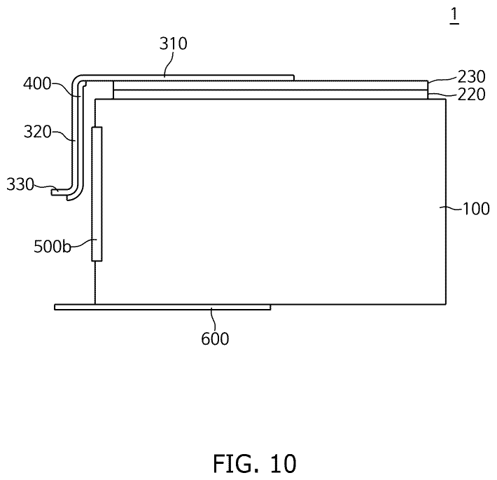

FIG. 10 illustrates a side view showing a secondary battery according to another embodiment of the present disclosure.

Referring to FIG. 10 with respect to FIG. 2, according to another embodiment, the extent to which an insulating member 500b is attached to the outer wall of the receiving can 100 may be a minimum extent corresponding to the first extension 320. Herein, the minimum extent to which the insulating member 500b is attached may be a range determined by a plurality of tests to at least a range in which short-circuiting between the first tab 300 and the receiving can 100 may be minimized. Accordingly, the cost of the process for manufacturing the secondary battery 1 may reduce be reduced.

This embodiment of the present disclosure is the same as the embodiment of the present disclosure described above with reference to FIG. 2, except that the configuration with respect to the range in which the insulating member 500b of the secondary battery 1 is attached is different from the configuration with respect to the range in which the insulating member 500 of the secondary battery 1 is attached described above with reference to FIG. 2, and therefore detailed description of the remaining configurations will be omitted.

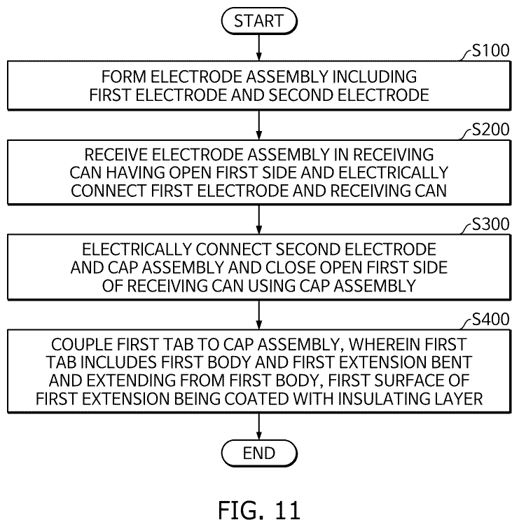

FIG. 11 illustrates a flowchart showing a method of manufacturing a secondary battery according to an embodiment of the present disclosure.

Referring to FIG. 11, in step S100, an electrode assembly 10 including a first electrode 11 and a second electrode 12 may be provided.

According to an embodiment, the electrode assembly 10 including the first electrode 11 and the second electrode 12 may be provided. Herein, the first electrode 11 may be a negative electrode, and the second electrode 12 may be a positive electrode. For example, the electrode assembly 10 may be a wound electrode assembly 10 formed by winding a structure in which a separator, i.e., an insulator, is provided between the first electrode 11 and the second electrode 12. In another example, the electrode assembly 10 may be a laminated electrode assembly 10 having a structure in which the first electrode 11 and the second electrode 12 are alternately stacked (or laminated) with the separator provided therebetween, or may be any structure including the first electrode 11 and the second electrode 12. The structure of the electrode assembly 10 described above is merely illustrative, and the present disclosure is not limited thereto.

The electrode assembly 10 may further include a positive electrode tab 13 and a negative electrode tab 14. The positive electrode tab 13 may be separately formed and connected to the uncoated portion of the second electrode 12, or may be formed by stamping a portion of the uncoated portion. The positive electrode tab 13 may extend upward from the uncoated portion to contact the cap assembly 200. The above-described configuration of the positive electrode tab 13 in contact with the cap assembly 200 is merely illustrative, but is not intended to be limiting. The contact between the positive electrode tab 13 and the cap assembly 200 may electrically connect the second electrode 12 and the cap assembly 200. The negative electrode tab 14 may be separately formed and connected to the uncoated portion of the first electrode 11, or may be formed by stamping a portion of the uncoated portion. The negative electrode tab 14 may extend downward from the uncoated portion to contact the receiving can 100. The above-described configuration of the negative electrode tab 14 in contact with the receiving can 100 is merely illustrative, and is not intended to be limiting. The contact between the negative electrode tab 14 and the receiving can 100 may electrically connect the first electrode 11 and the receiving can 100. The above-described configuration of the negative electrode tab 14 in contact with the receiving can 100 is merely illustrative, but is not intended to be limiting. The contact between the negative electrode tab 14 and the receiving can 100 may electrically connect the first electrode 11 and the receiving can 100.

In step S200, the electrode assembly 10 may be received in the receiving can 100 having the open first side, and the first electrode 11 and the receiving can 100 may be electrically connected.

According to an embodiment, the receiving can 100 may form the overall contour of the secondary battery 1. For example, the receiving can 100 may have an open cylindrical shape. The receiving can 100 may be open in the first side to receive the electrode assembly 10. The receiving can 100 may include a circular bottom surface and a sidewall extending vertically from the circumference of the bottom surface. The receiving can 100 may be formed such that the diameter of the bottom face is greater than the height of the sidewall, such that the secondary battery 1 may be implemented as a button or coin battery. The top surface of the receiving can 100 opposite the bottom surface may be open to expose a receiving space capable of receiving the electrode assembly 10.

As described above, in a case where the receiving can 100 receives the electrode assembly 10, the negative electrode tab 14 of the electrode assembly 10 may be in contact with the receiving can 100, and electrically connect the first electrode 11 of the electrode assembly 10 and the receiving can 100. The receiving can 100 electrically connected to the first electrode 11 may function as a negative electrode.

In step S300, the second electrode 12 and the cap assembly 200 may be electrically connected, and the cap assembly 200 may be used to seal the open first side of the receiving can 100.

According to an embodiment, the cap assembly 200 may cover the open first side of the receiving can 100 to enclose or seal the electrode assembly 10 from the outside. The cap assembly 200 may be electrically coupled to the second electrode 12 of the electrode assembly 10.

According to an embodiment, the cap assembly 200 may include a cap plate 210, a cap insulating layer 220, and a cap 230. The cap plate 210 may include a first open area, and may be in contact an open first side of the receiving can 100. An outer surface of the cap plate 210 may have a shape in which the upper portion protrudes more than the lower portion, and may be coupled to the receiving can 100 while engaging with a stepped portion on the outer wall of the receiving can 100. The cap plate 210 may be disc-shaped, with a first open area provided in the central portion and an outer end corresponding to the shape of the receiving can 100. A portion of the cap 230 extending through the first open area of the cap plate 210 may be in contact with the positive electrode tab 13 connected to the electrode assembly 10.

According to an embodiment, the cap insulating layer 220 may be disposed on the cap plate 210. The cap insulating layer 220 may be disposed between the cap plate 210 and the cap 230 to insulate the cap 230 and the cap plate 210 from each other. The cap insulating layer 220 may have a second open area, and may be disc-shaped with the second open area provided in the central portion. The cap insulating layer 220 may be disposed on the cap plate 210 and may have the second open area that is concentric with the first open area of the cap plate 210 but has a diameter smaller than or equal to the diameter of the first open area, thereby electrically insulating the cap 230 disposed over the cap insulating layer 220 from the cap plate 210.

According to an embodiment, the cap insulating layer 220 may have a size corresponding to the size of the cap 230 disposed thereover. That is, the cap insulating layer 220 may have a diameter that is greater than or equal to the diameter of the cap 230, thereby electrically insulating the cap 230 and the cap plate 210.

According to an embodiment, the cap 230 may cover the cap plate 210 and enclose or seal the electrode assembly 10. The cap 230 may extend through the first open area of the cap plate 210 and be connected to the second electrode 12 of the electrode assembly 10. The cap 230 may be disposed over the cap insulating layer 220 to be electrically insulated from the cap plate 210. The cap 230 may extend from the center of the bottom surface to extend through the first open area without contacting the first open area, and may be in contact with the positive electrode tab 13 of the electrode assembly 10. The cap 230 may be connected to the second electrode 12 through the positive electrode tab 13 to function as a positive electrode. The cap 230 may be disposed on the uppermost layer of the cap assembly 200, and may be connected to a first tab 300, which is an external terminal to be connected to a load.

According to an embodiment, after the receiving can 100 and the cap assembly 200 are coupled, the method may further include a step of attaching an insulating member 500 to a first region of the outer wall of the receiving can 100.

As will be described later, in a case where the first tab 300 is coupled to the cap assembly 200, the insulating member 500 may be attached to a region of the outer wall of the receiving can 100 facing the first extension 320 of the first tab 300. Herein, the insulating member 500 may include, but is not limited to, polyimide. The insulating member 500 may be attached with tape, but is not limited thereto. The insulating member 500 may include, but is not limited to, polyimide. The insulating member 500 may be implemented as tape for attachment, but is not limited thereto.

In step S400, the first tab 300 may be coupled to the cap assembly 200. Herein, the first tab 300 may include a first body 310 and a first extension 320 bent and extending from the first body 310, a first surface of the first extension 320 being coated with an insulating layer 400. The first tab 300 may be an external terminal to be connected to a load. The first tab 300 may be electrically connected to the second electrode 12 of the electrode assembly 10 through the cap assembly 200 to function as a positive electrode.

According to an embodiment, the first tab 300 may include a first body 310 coupled to the cap assembly 200 and the first extension 320 bent and extending from the first body 310.

According to one embodiment, the first body 310 may be coupled to the cap 230 disposed on the uppermost layer of the cap assembly 200. A region of the first body 310 may be in contact with the top surface of the cap 230 around the center of the top surface of the cap 230 in a peripheral direction. The remaining region of the first body 310 may extend horizontally so as not to contact the cap plate 210 or the receiving can 100. The first body 310 may extend horizontally beyond the outermost edge of the receiving can 100 and be bent inwardly toward the outer wall of the receiving can 100.

According to an embodiment, the first extension 320 may be bent and extend downward from a first end of the first body 310 inwardly toward the outer wall of the receiving can 100. A first surface of the first extension portion 320 may be coated with the insulating layer 400. The insulating layer 400 may be coated on the first surface of the first extension 320 facing the outer wall of the receiving can 100. The insulating layer 400 may be, but is not limited to, a polymer coating. The insulating layer 400 may be coated with a thickness of 20 μm to 60 μm, but is not limited thereto. The insulating member 500 may be disposed on a first region of the outer wall of the receiving can 100 corresponding to the first extension 320. The insulating layer 400 coated on the first extension portion 320 and the insulating member 500 disposed on the outer wall of the receiving can 100 may prevent a short circuit between the first extension portion 320 and the receiving can 100. In addition, in order to prevent a short circuit between the first extension portion 320 and the receiving can 100, the first tab 300 may be coupled to the cap assembly 200 by adjusting the position thereof so that the first insulating layer 400 coated on the first extension 320 and the insulating member 500 attached to the outer wall of the receiving can 100 are spaced apart by at least a predetermined distance X.

According to an embodiment, the first tab 300 may further include a second extension 330 bent and extending from the first extension 320. The second extension 330 may be bent upward and extend outward from a first end of the first extension 320.

According to an embodiment, the method may further include a step of coupling the second tab 600 to a second side of the receiving can 100 opposite the open first side of the receiving can 100. The second tab 600 may be an external terminal to be connected to a load. The second tab 600 may be electrically connected to the first electrode 11 of the electrode assembly 10 through the receiving can 100 to function as a negative electrode.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF REFERENCE SYMBOLS

10: electrode assembly
100: receiving can
200: cap assembly
300: first tab
400: insulating layer
500: insulating member
600: second tab

What is claimed is:

1. A secondary battery comprising:
an electrode assembly comprising a first electrode and a second electrode;
a receiving can having an open first side to receive the electrode assembly and which is electrically connected to the first electrode;
a cap assembly configured to cover the open first side of the receiving can to enclose the electrode assembly from outside and the cap assembly being electrically connected to the second electrode;
a first tab comprising a first body coupled to the cap assembly and a first extension bent and extending from the first body; and
an insulating layer coated on a first surface of the first extension facing an outer wall of the receiving can.

2. The secondary battery as claimed in claim 1, further comprising an insulating member disposed in a first region of the outer wall of the receiving can corresponding to the first extension.

3. The secondary battery as claimed in claim 2, wherein the first tab is coupled to the cap assembly such that the insulating layer and the insulating member are spaced apart from each other by a distance of 50 μm or more.

4. The secondary battery as claimed in claim 2, wherein an area over which the insulating member is disposed is greater than an area over which the insulating layer is coated.

5. The secondary battery as claimed in claim 1, wherein the first extension is bent and extends downward from a first end of the first body inwardly toward the outer wall of the receiving can.

6. The secondary battery as claimed in claim 2, wherein the first extension is bent and extends downward from a first end of the first body inwardly toward the outer wall of the receiving can, and the insulating layer and the insulating member are provided between the first extension and the outer wall of the receiving can.

7. The secondary battery as claimed in claim 1, wherein the insulating layer comprises a polymer coating.

8. The secondary battery as claimed in claim 2, wherein the insulating layer comprises polyimide tape.

9. The secondary battery as claimed in claim 1, wherein the first tab comprises a second extension bent and extending from the first extension.

10. The secondary battery as claimed in claim 9, wherein:
the first extension is bent and extends downward from a first end of the first body inwardly toward the outer wall of the receiving can, and
the second extension is bent and extends upward and outward from a first end of the first extension.

11. The secondary battery as claimed in claim 9, wherein the insulating layer is further coated on a region of the second extension.

12. The secondary battery as claimed in claim 10, wherein a first angle between the first body and the first extension bent inward is smaller than a second angle between the first extension and the second extension bent outward.

13. The secondary battery as claimed in claim 7, wherein:
a first surface of the first body not in contact with the cap assembly is coated with nickel (Ni), and
the first surface of the first extension facing the outer wall of the receiving can is coated with the insulating layer, and a second surface of the first extension is coated with tin (Sn).

14. The secondary battery as claimed in claim 9, wherein opposite surfaces of the second extension are coated with tin (Sn).

15. The secondary battery as claimed in claim 1, further comprising a second tab coupled to a second side of the receiving can opposite the open first side.

16. The secondary battery as claimed in claim 1, wherein the cap assembly comprises:
a cap plate configured to comprise a first open area and coupled to the open first side of the receiving can;
a cap configured to cover the cap plate and enclosing the electrode assembly, the cap extending downward through the first open area and being connected to the second electrode; and
a cap insulating layer disposed between the cap plate and the cap to insulate the cap plate and the cap.

17. A method of manufacturing a secondary battery, the method comprising:
forming an electrode assembly comprising a first electrode and a second electrode;
receiving the electrode assembly in a receiving can having an open first side and electrically connecting the receiving can to the first electrode;
electrically connecting the second electrode to a cap assembly of the secondary battery and covering and enclosing the open first side of the receiving can; and
coupling a first tab to the cap assembly, wherein the first tab comprises a first body and a first extension bent and extending from the first body, a first surface of the first extension being coated with an insulating layer.

18. The method as claimed in claim 17, further comprising, before coupling the first tab to cap assembly, attaching an insulating member to a first region of an outer wall of the receiving can facing the first extension.

19. The method as claimed in claim 18, wherein the insulating member comprises polyimide tape.

20. The method as claimed in claim 17, wherein the first extension is bent and extends inward and downward from a first end of the first body and the first tab further comprises a second extension bent and extending outward and upward from a first end of the first extension.
